(19) United States
(12) Patent Application Publication
(10) Pub. No.: US 2007/0044617 A1
(43) Pub. Date: Mar. 1, 2007

(54) Web material cutting device

(76) Inventor: Rudolf Pavlik, Lincolnshire, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/210,304

(22) Filed: Aug. 24, 2005

(51) Int. Cl. B26D 5/08; B26D 7/02

(52) U.S. Cl. 83/614; 83/455; 83/485

(57) ABSTRACT

A cutter assembly is provided having a rail and a blade housing. The rail includes support surface side, a mounting side and a first side. An aperture in the first side provides access to a central cavity. The blade housing includes a blade having first and second ends. The first end includes a fitting and the second end includes a handle. The fitting slidingly fits within and is retained within the central cavity. The blade is positioned substantially parallel to and moved into contact with a portion of the first side as the fitting is moved within the rail. The cutter assembly can be attached to a container housing a web material. The movement of the blade housing along the rail cutes the web material at a position directly adjacent the intersection of the support surface and the first surface.

### TECHNICAL FIELD

The invention relates to the field of cutting assemblies. Particularly, the invention relates to cutting assemblies for web materials.

### BACKGROUND OF THE INVENTION

Web materials (e.g., foil, plastic wrap, wax paper, gift wrap paper, and the like) are commonly sold in rolls. For a user to obtain a desired amount of the web material, the user must sever material from the roll. Several alternatives are currently used to sever material in a substantially straight line. The most common is a set of jagged teeth mounted to the lid of a container or box. The material is pulled against the teeth and severed, making a rough cut line. In addition, the jagged teeth are typically exposed and a user may cut his hand.

Other alternatives involve slidable cutters that are contained within a track mounted on the container. These cutters are either pre-attached to the container or shipped in the container with the end user attaching the cutter to the outside of the container. Current slidable cutters have tracks with two rails, with the cutter sliding between the two rails. With this two rail configuration, the web material is pulled over the rails. The cutter is then slid along the rails, cutting the material.

A disadvantage of the two rail configuration is that web material can sag between the two rails making it more difficult to cut because the material is not taut. In such a situation, the web material is pushed through the rails, causing bunching and wrinkling.

A further disadvantage may result from the manner in which the web material is secured or held down at the moment of cutting. Known two rail configurations have relied on a tacky surface on the rails to temporarily fix the web material in place. The addition of a tacky surface may add cost and sophistication to the process of manufacturing the rails. If the rails do not include a tacky surface and/or the web material (e.g., aluminum foil) does not respond to the tacky material, the web material will be difficult to cut without the user manually holding the web material against the rails at the moment of cutting.

### SUMMARY OF THE INVENTION

One embodiment of the present invention is a cutter assembly that includes a rail and a blade housing. The rail includes a support surface side, a mounting side and a first side. An aperture in the first side provides access to a central cavity within the rail. The blade housing includes a blade, a first end and a second end. The first end includes a fitting and the second end includes a handle. The fitting is sized and shaped to slidingly fit within and be retained within the central cavity. The blade is positioned substantially parallel to and is moved into contact with at least a portion of the first side as the fitting is moved along the rail. The present invention may be attached to a container housing a web material.

Another embodiment of the present invention defines a cutter assembly that includes a rail and a blade housing. The rail includes a support surface side, a mounting side and first and second sides. An aperture in the first side provides access to a central cavity that is defined by the support surface side, the mounting side, and the first and second sides. The blade housing includes a blade, a first end and a second end. The first end includes a fitting and the second end includes a handle. The fitting is sized and shaped to slidingly fit within and be retained within the central cavity. The first end and the second end move along a longitudinal centerline of the rail. The blade is positioned to move along a line parallel to but offset or spaced from the centerline. The blade is brought into contact with at least a portion of the first side as the blade housing is advanced along the rail.

### BRIEF DESCRIPTION OF THE DRAWINGS

For the purpose of illustrating the invention, there is shown in the drawings various forms which are presently disclosed; it being understood, however, that this invention is not limited to the precise arrangements and instrumentalities particularly shown.

FIG. 1 is a perspective view of a cutter assembly in accordance with the present invention.

FIG. 2 is a cross sectional view of the cutter assembly of FIG. 1.

FIG. 3 is a perspective view of a cutter assembly in accordance with the present invention as mounted on a cylindrical container.

FIG. 4 is a perspective view of a cutter assembly in accordance with the present invention as mounted on a rectangular container.

### DETAILED DESCRIPTION OF THE INVENTION

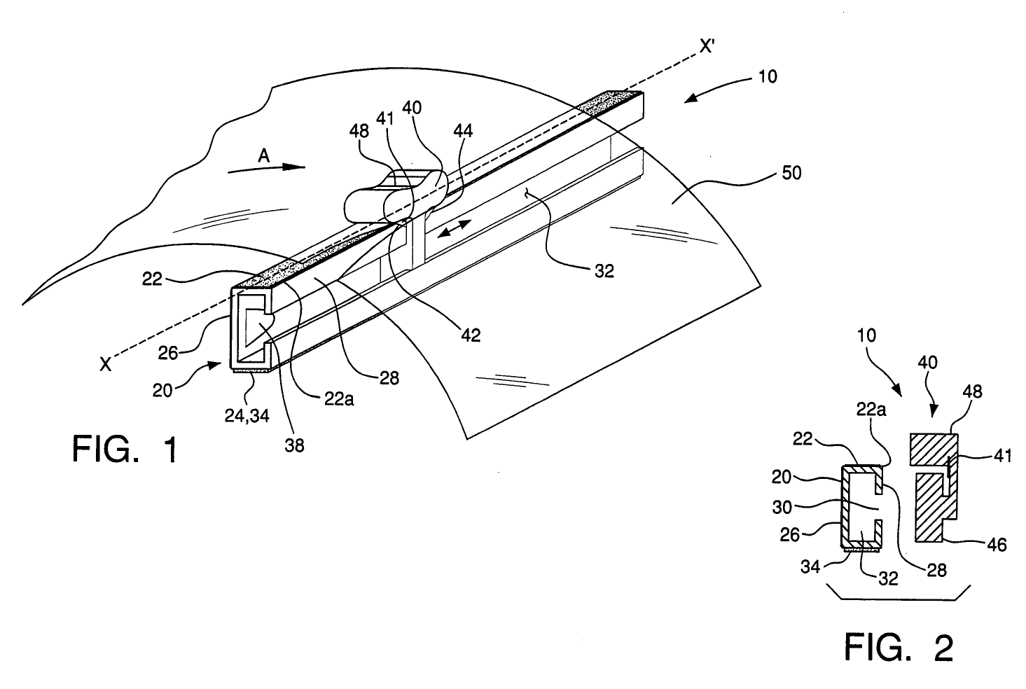

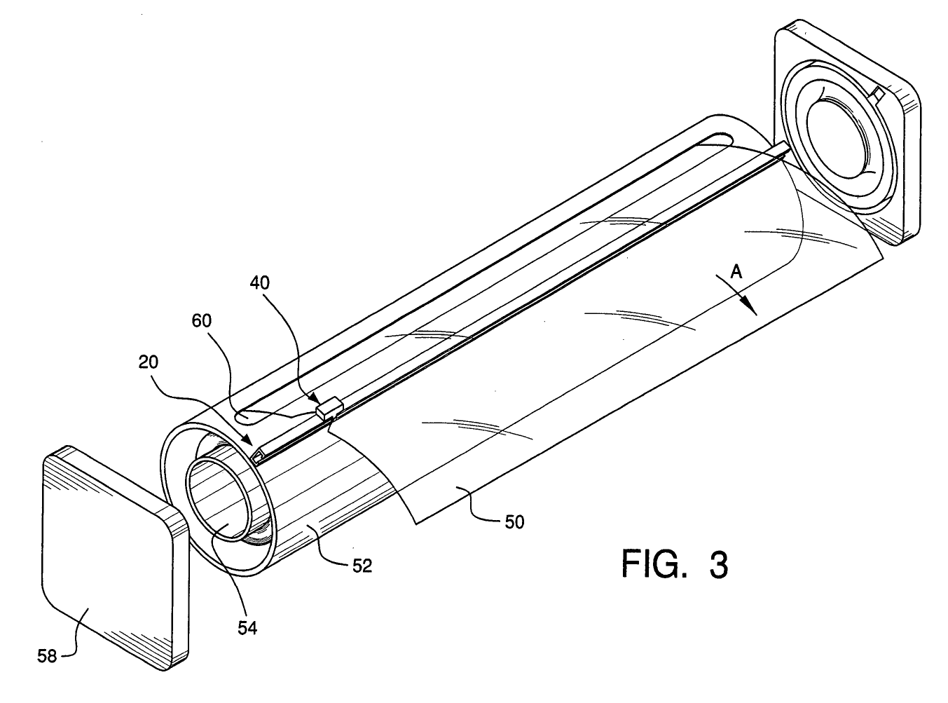

In the drawings, where like numerals identify like elements, there is shown in FIGS. 1 and 2 a cutter assembly which is generally identified by the numeral 10. The cutter assembly 10 includes a “C-shaped” rail 20 and a blade housing 40. The rail 20 has a support surface side 22, a mounting side 24 opposite the support surface 22. The rail 20 also has a second side 26 opposite a first side 28. An aperture 30 in the first side 28 provides access to a central cavity 32, which is defined by the support surface 22, mounting side 24, first side 28 and second side 26.

As illustrated, the first side 28 is positioned substantially perpendicular to the support surface 22 and the mounting side 24. However, it is within the scope of the present invention that the first side 28 can be oriented in manner that is not perpendicular to one or both of the support surface 22 and the mounting side 24.

The blade housing 40 includes a blade 41 rigidly mounted therein. The blade 41 has first and second edges 42, 44. The edges 42, 44 have a sharp cutting surface, such that they are capable of shearing a web material. The blade housing 40 is adapted to travel bilaterally along the rail 20, and to cut a web material 50 as the blade travels along the rail. Web materials of the type contemplated by the present invention include foil, plastic wrap, wax paper, gift wrap, and the like.

The blade housing 40 also includes a first end and a second end. The second end of the housing 40 includes a handle 48 for a user to grasp.

The first end includes a fitting 46 sized and shaped to slidingly fit within the central cavity 32. As used herein, the phrase “slidingly fit” means that the dimensions of the fitting 46 are such that the fitting 46 can be moved within the central cavity 32 and does not become wedged or lodged in the central cavity 32 when the blade housing 40 is moved along the rail 20. For example, if the profile shape of the central cavity is a square, the fitting would have a substantially square profile that is smaller in dimensions than the central cavity profile; if the profile shape of the central cavity is a circle, the fitting would have a substantially circular profile that is smaller in dimensions than the central cavity profile; if the profile shape of the central cavity is a trapezoid, the fitting would have a substantially trapezoidal profile that is smaller in dimension than the central cavity profile; and so on.

The fitting 46 is also sized and shaped to be retained within the central cavity. As used herein, the phrase “be retained within” means that the fitting 46 can only be removed from the central cavity 32 through one of the two longitudinal ends of the rail 20. Preferably, the dimensions of the fitting 46 are sufficient to allow the fitting 46 to be retained within the central cavity 32 and still be slidingly fit within the central cavity 32.

As illustrated, the fitting 46 and the handle 48 are oriented along a longitudinal centerline X-X′ of the rail 20. The blade 41 of the blade housing 40 is preferably aligned parallel to this centerline X-X′, but offset therefrom. However, the blade 41 can be oriented such that it is not parallel to the longitudinal centerline X-X′.

As illustrated, the blade 41 is also positioned substantially parallel to and in contact with at least a portion of the first side 28 as the blade housing 40 is advanced along the rail 20. As used herein, “in contact with” means that either the surface of blade 41 is in physical contact with the first side 28 or that the surface of blade 41, although not in physical contact with the first side 28, is in such close proximity to the first side 28 that only minor pressure (e.g., pressure exerted by a user's finger) is required to place the surface of the blade 41 in physical contact with the first side 28. Preferably, the blade 41 is in contact with an intersection 22a of the support surface 22 and the first side 28 as the fitting 46 is moved within the rail 20.

In operation, the blade housing 40 and the rail 20 are formed separately. The blade housing 40 is introduced into a longitudinal end of the rail 20 such that the fitting 46 slides past a tab 38 or similar retainer in the second side 26. Once introduced, the tab 38 provides an impediment to the fitting 46 so as to prevent the fitting 46 from sliding out of the ends of cavity 32 within the rail 20. Other impediments or retainers, such as a detachable end cap, can be used in place of, or in addition to, the tab 38.

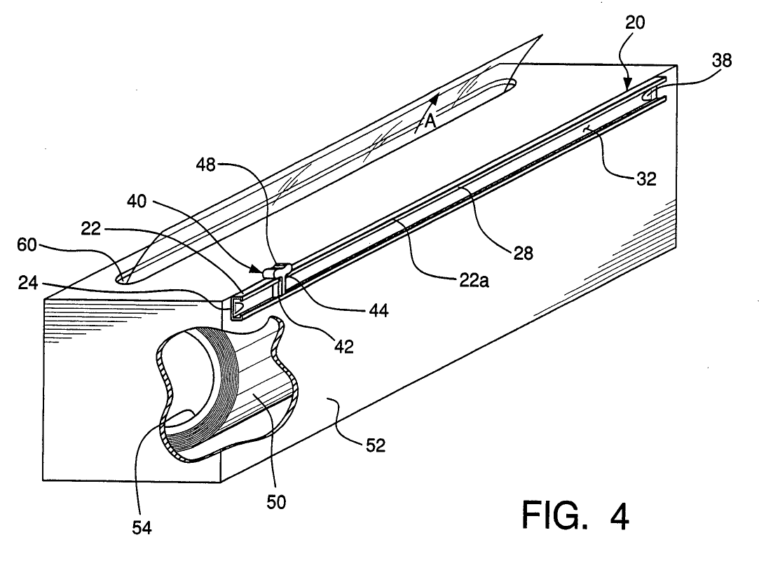

As shown in FIGS. 3 and 4, the mounting side 24 of the rail 20 is attached to a container 52, which houses a roll 54 of web material 50. As shown in FIG. 3, the mounting side 24 is opposite the support surface 22. As shown in FIG. 4, the mounting side 24 is opposite the first side 28.

Preferably, the rail 20 is attached to the container 52 by way of a double-sided tape 34 being attached to the mounting side 24 and the container 52. Alternatively, the rail 20 can be mounted onto the container 52 using other securing mechanisms such as glue, clamps, snaps or hook-and-loop type fasteners.

The container 52 as shown in FIG. 3 is substantially cylindrical with square end caps 58 that support the container body. The container 52 as shown in FIG. 4 is a rectangular box structure. Here the rail 20 has a support surface 22 that is substantially coplanar with the top surface of the container 52. Also, the mounting surface 24 is positioned opposite the first surface 28 on the rail 20 and is attached to a side of the container 52 adjacent its top surface and the web opening 60. Whether the container 52 is cylindrical, box-like, or another configuration (e.g., a box-like configuration with a notch or groove for the cutter assembly, a container with a lid), it can be constructed of a paper (e.g. cardboard), plastic (e.g. PVC), or metal (e.g. aluminum).

As illustrated, the rail 20 has a width that is greater than the width of the web material 50. The greater width allows the blade housing 40 to be positioned outside the path of the web material 50 when the blade housing 40 is positioned at an end of the rail 20. With the blade housing 40 at an end of the rail 20, the web material 50 is removed from the container 52 through an opening 60. The material 50 is fed into the cutter assembly 10 in the direction of the arrow A. The material 50 is advanced over the support surface 22, which provides a single, uninterrupted support for the material, to a position beyond the intersection 22a of the support surface 22 and the first side 28 to the desired cut length. The blade housing 40 is then advanced along the rail 20 from the end at which the blade housing 40 is initially positioned toward the opposing end.

As the blade housing moves along the rail 20, the handle 48 is pressed down so that it engages the support surface 22, thereby holding down the web material 50 at the moment of cutting to allow one of the blade edges 42, 44 to sever the web material 50 along the intersection 22a. The holding down of the web material 50 by the handle 48 allows for a more efficient and more accurate cut without the need for the rail 20 to be made from multiple substrates, at least one providing a rigid construction and at least one providing attraction and/or adhesion properties to the support surface 22. As a result, the rail 20 of the present invention can be made from a single substrate. In addition, the ability of the handle 48 to hold down the material 50 at the moment of cutting eliminates the need for a user to manually hold down the material during cutting.

Although the configuration of the present cutter assembly provides for the handle 48 to engage the support surface 22 so as to secure the web material 50 at the moment of cutting, attraction and/or adhesion properties of the support surface 22 provide a supplemental force to secure the web material 50 and keep it flat before and after cutting.

Preferably, the rail 20 is co-extruded so as to provide a substantially rigid overall construction and a tackiness on the support surface 22 such as disclosed in U.S. Pat. App. No. 2002/0117038 to Vegliante, et al. For example, the rail 20 can be made from a styrene based elastomer co-extruded on a high impact polystyrene (“HIPS”), a plasticized polyvinyl chloride (“PVC”) co-extruded on a rigid PVC, a tactified HIPS co-extruded on a rigid HIPS, or some other similar construction. Other materials such as rubbers, elastomers, plastics, glass, silicon, metal, acrylic, PVC, and other similar materials which provide attraction of the film thereto are also contemplated. Additionally, multiple materials can be used in combination with one another. The attraction of the web material 50 to the support surface 22 is by way of a slight adhesion, a static charge or other similar phenomena.

Alternatively, the rail 20 is coated with a material to provide the support surface 22 with an adhesive quality. Suitable adhesive materials include pressure sensitive adhesives, natural rubbers, rubbers, and rubber cements. The specific type of adhesive material generally is dependent on the type of web material with which the cutter assembly is being used. The adhesive quality allows a web material to be temporarily fixed on the rail 20 to facilitate even cutting with the blade edges 42, 44.

Preferably, as shown in FIGS. 1 and 4, the handle 48 is contoured to allow a user's finger to easily grasp the blade housing and prevent the user's finger from slipping off of the handle 48 as the blade housing 40 is moved along the rail 20. The contour shape also aids in focusing the point of contact into the center of the blade housing 40, thus allowing a more even cut. As shown in FIG. 3, the handle 48 is substantially rectangular. The rectangular configuration allows a user to move the blade housing along the rail by pinching and sliding the handle 48.

Preferably, the handle 48 is manufactured from a molded plastic material so as to provide a rigid construction. Examples of suitable plastic materials include HIPS, PVC, polyethylene, polypropylene, and the like. The handle 48 can have a co-extruded tactified surface that provides for a more secure engagement between a user's finger and the handle 48. Examples of suitable materials for the tactified surface include plasticized PVC, tactified HIPS, rubbers, elastomers, and the like. Alternatively, the handle 48 can be coated with an adhesive material such as pressure sensitive adhesives, natural rubbers, rubbers, and rubber cements. The handle 48 also can include grooves to provide for a better engagement between a user's finger and the handle 48.

As shown in FIG. 1, the blade edges 42, 44 are at an angle in relation to the handle 48. Preferably, the angle is from about 10 degrees to about 90 degrees; more preferably from about 30 degrees to about 60 degrees; and most preferably about 45 degrees. The angled orientation of the blade edges provides for more efficient cutting of the web material.

The blade can be manufactured from any material suitable for cutting the web. Suitable materials include stainless steel, aluminum, plastic, tungsten and the like. Preferably, the blade is steel and more preferably 440 stainless steel.

The blade is preferably molded into the blade housing 40. Alternatively, the blade may be secured by riveting to the housing, welding, adhesive or by some other method.

Although FIG. 1 shows one blade with two edges 42, 44, the blade housing may include two or more blades. One blade with two sharp edges is preferred and provides the benefits of two blades (i.e., capability of bilateral cutting, etc.) while providing the ease of only having to install one blade. More than one cutting edge provides greater flexibility in cutting, although a single blade edge may be used if desired.

It will be appreciated by those skilled in the art, that the present invention may be practiced in various alternate forms and configurations. The previously detailed description of the disclosed embodiments is presented for purposes of clarity of understanding only, and no unnecessary limitations should be implied there from.

What is claimed is:

1. A cutter assembly for cutting a web material, the assembly comprising a rail and a blade housing;
the rail comprising a support surface side, a mounting side and a first side, an aperture in the first side providing access to a central cavity within the rail; and
the blade housing comprising a blade, a first end and a second end, the first end comprising a fitting and the second end comprising a handle,
wherein the fitting is sized and shaped to slidingly fit within and be retained within the central cavity, and wherein the blade is positioned to move substantially parallel to and in contact with at least a portion of the first side as the fitting is moved within the rail.

2. A cutter assembly of claim 1 wherein the mounting side is opposite the support surface side.

3. A cutter assembly of claim 1 wherein the mounting side is opposite the first side.

4. A cutter assembly of claim 1 wherein the rail comprises high impact polystyrene.

5. A cutter assembly of claim 4 wherein the high impact polystyrene is co-extruded with a styrene based elastomer.

6. A cutter assembly of claim 1 wherein the support surface is coated with an adhesive.

7. A cutter assembly of claim 6 wherein the support surface material comprises a tactified high impact polystyrene.

8. A cutter assembly of claim 1 wherein the blade is stainless steel.

9. A cutter assembly of claim 1 wherein the blade comprises two edges with a sharpness capable of cutting a web material.

10. A cutter assembly of claim 1 wherein the blade housing comprises two blades.

11. A cutter assembly of claim 1 wherein the handle comprises a tactified surface.

12. A cutter assembly of claim 1 wherein the handle comprises grooves.

13. A cutter assembly of claim 1 wherein a first side of a double sided tape is attached to the mounting side of the rail.

14. A cutter assembly of claim 13 wherein a second side of the double sided tape is attached to a container.

15. A cutter assembly comprising a rail and a blade housing;
the rail comprising a support surface side, a mounting side and first and second sides, an aperture in the first side providing access to a central cavity defined by the support surface side, the mounting side, and the first and second sides; and
the blade housing comprising a blade, a first end and a second end, the first end comprising a fitting and the second end comprising a handle, the fitting sized and shaped to slidingly fit within and be retained within the central cavity,
wherein the first end and the second end are positioned along a longitudinal centerline of the rail, and the blade is positioned to move along a line parallel to but offset from the centerline, the blade contacting at least a portion of the first side as the blade housing is advanced along the rail.

16. A package for housing a web material, comprising:
a container;
a roll of web material positioned inside the container;
a cutter assembly comprising a rail and a blade housing,
the rail comprising a support surface, a mounting side and first and second opposing sides, the mounting side attached to the container and an aperture in the first side providing access to a central cavity, and
the blade housing comprising a blade, a first end and a second end, the first end comprising a fitting and the second end comprising a handle
wherein the fitting is sized and shaped to slidingly fit within and be retained within the central cavity, and wherein the blade is positioned in contact with the first side and move along the first side at its intersection with the support surface as the fitting is moved within the rail.

17. A package as claimed in claim 16, wherein the cutter assembly is secured to the container along its mounting side, adjacent an opening in the container wherein the web material is directed from the roll.

18. A package as claimed in claim 17, wherein the container is substantially cylindrical.

19. A package as claimed in claim 17 wherein the container is substantially rectangular in cross section.

20. A package as claimed in claim 19 wherein the support surface is positioned substantially coplanar with one side surface of the container rectangular cross section and the mounting surface is positioned on an adjoining side surface of the container.
